(19) United States
(12) Patent Application Publication
(10) Pub. No.: US 2005/0023098 A1
(43) Pub. Date: Feb. 3, 2005

(54) Energy recovery system

(76) Inventor: Imad Mahawili, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/880,690

(22) Filed: Jun. 30, 2004

Related U.S. Application Data
(60) Provisional application No. 60/530,938, filed on Dec. 19, 2003.
(60) Provisional application No. 60/483,943, filed on Jul. 1, 2003.

(51) Int. Cl. B60M 1/00

(52) U.S. Cl. 191/18

(57) ABSTRACT

An energy recovery system including a device that produces a magnetic field adapted for mounting to a vehicle and a stationary conductor adapted for placing in or adjacent the path of the vehicle wherein the magnetic field induces current to flow through the conductor when the vehicle moves past the conductor.

This application claims priority from U.S. provisional application Ser. No. 60/530,938, filed Dec. 19, 2003, and U.S. provisional application Ser. No. 60/483,943, filed Jul. 1, 2003, entitled ENERGY RECOVERY SYSTEM, by Applicant Imad Mahawili, Ph.D, and are incorporated herein in their entireties.

### TECHNICAL FIELD AND BACKGROUND OF THE INVENTION

The present invention relates to a system that recovers energy from a moving object, such as a vehicle.

Energy consumption of non-renewable resources and the pollution created by this energy consumption, as well as pollution created when energy is generated, has long been a concern. Efforts to curb consumption of non-renewable energy sources and to reduce pollution, for example in vehicles, has led to the development of electric and/or hybrid vehicles. While electric and hybrid vehicles have reduced the consumption of some non-renewal resources and generate less pollution, the use of electric vehicles, which require recharging, simply shifts or reallocates the location of the pollution between vehicles and power plants—typically coal fired power plants—and, further, shifts at least some of the energy consumption from one non-renewable source to another non-renewable source—such as from gasoline to coal. However, the total amount of energy consumed by both types of vehicles has remained generally unchanged.

While great strides have been made to increase the energy efficiency of vehicles, there are still inherent energy inefficiencies and waste that are not currently addressed. For example, when a vehicle is driven up a hill or an incline and thereafter descends with the engine running, energy is wasted because it is not recoverable at present.

Consequently, there is a need for a system that can recover wasted energy, such as from a vehicle, and further that can covert the wasted energy into a source of useable energy for immediate or later use.

### SUMMARY OF THE INVENTION

Accordingly, the present invention provides an energy recovery system that recovers energy from a moving object, such as a vehicle, which can be used or stored for later use.

In one form of the invention, an energy recovery system includes a device that produces a magnetic field, which is adapted for mounting to a vehicle, such as an automobile, a train, or the like, and a stationary conductor that is adapted for placing in or adjacent the path of the vehicle such that the magnetic field induces current to flow through the conductor when the vehicle moves past the conductor, which is harnessed and stored for immediate or later use.

For example, the device may comprise a permanent magnet or an electromagnet. Where the device comprises an electromagnet, the vehicle optionally includes a control for actuating the electromagnet. In addition the recovery system may include a sensor, which senses when the vehicle is in proximity to the stationary conductor and, further, generates an actuating signal to the control for actuating the electromagnet.

In other aspects, the conductor is coupled to an energy storage device, such as a capacitor or a battery. Alternately or in addition, the conductor may be coupled to an energy conversion system. For example, the energy conversion system may include at least one hydrogen fuel cell. In addition, the energy conversion system may include an electrolysis system for generating at least hydrogen for the hydrogen fuel cell.

In yet other aspects, the conductor comprises a bundle of wiring. For example, the bundle of wiring may be adapted for being mounted in a road surface.

Accordingly to yet other aspects, the vehicle includes a wheel, with the device mounted to the wheel, for example, at the perimeter of the wheel. Preferably, the negative pole of the device faces outwardly from the center of the wheel or the wheel axle. Further, the wheel may include a plurality of the devices, with their respective negative poles facing outwardly from the center of the wheel or the wheel axle.

In another form of the invention, a method of recovering energy includes a mounting a magnetic field generating device to a vehicle, providing a stationary conductor either in the path of the vehicle or adjacent the path of the vehicle wherein the magnetic field generates current flow in the conductor when the vehicle travels past or over the conductor. The conductor is coupled to an energy storage device, a transmission system, or an energy conversion system so that the energy recovered from the vehicle can be used separate from the vehicle.

In one aspect, the conductor is coupled to an energy storage device. In a further aspect, the energy storage device is coupled with an energy transmission system. Optionally, the system detects when the stored energy exceeds a predetermined threshold and transmits energy from the energy storage device to the energy transmission system when the stored energy exceed the predetermined threshold.

In another aspect, the system selectively actuates the magnetic field generating device to thereby selectively generate the magnetic field.

Accordingly, it can be understood that the energy recovery system of the present invention can recover energy from moving object, such as a vehicle, to convert the energy, which for example may otherwise be wasted energy, into an energy supply for immediate or later use.

These and other objects, advantages, purposes, and features of the invention will become more apparent from the study of the following description taken in conjunction with the drawings.

### DETAILED DESCRIPTION OF THE DRAWINGS

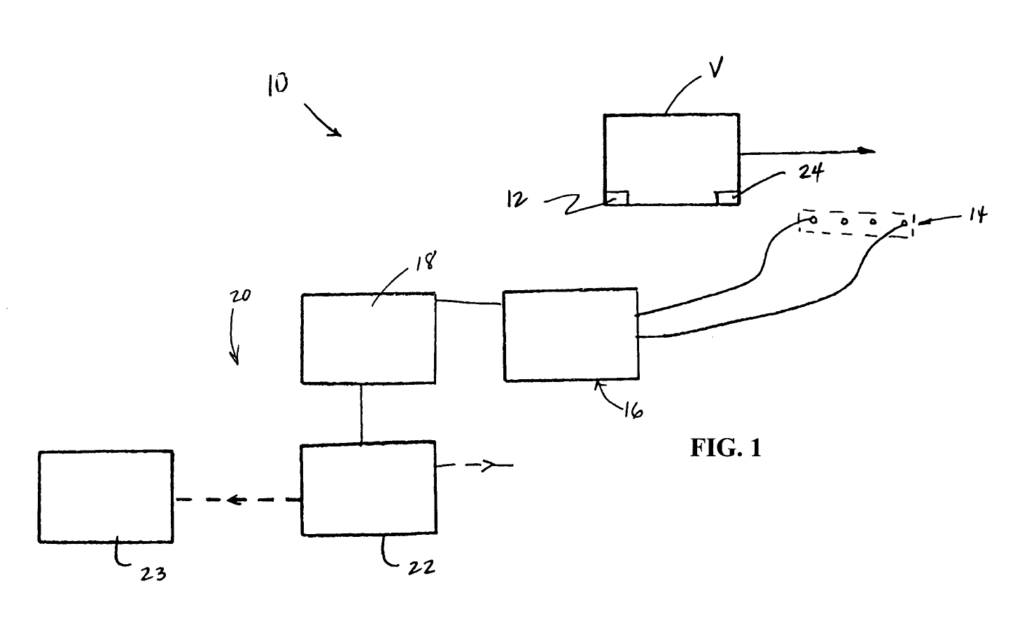

FIG. 1 is a schematic drawing of the energy recovery system of the present invention; and

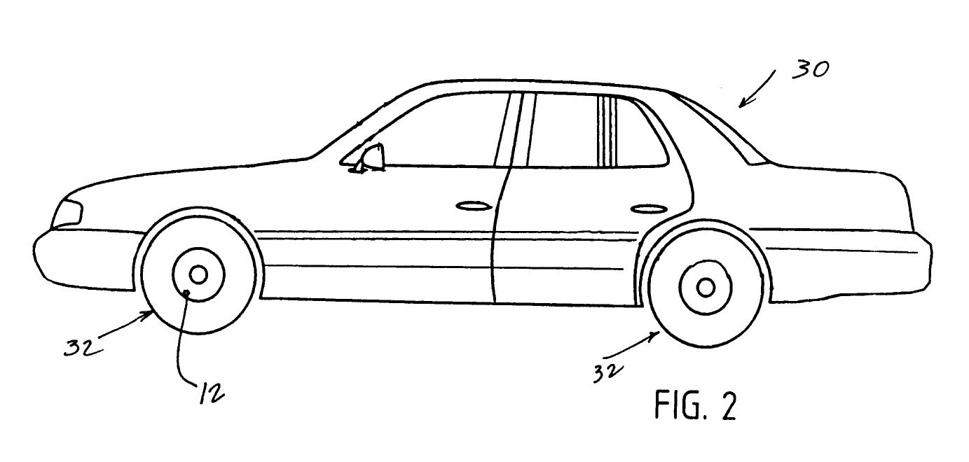

FIG. 2 is a schematic view of the mounting an electromagnetic field generator on a vehicle.

### DETAILED DESCRIPTION OF THE PREFERRED EMBODIMENTS

Referring to FIG. 1, the numeral 10 generally designates an energy recovery system of the present invention. As will be more fully described below, the energy recovery system of the present invention uses the motion of a moving object to generate energy and/or resources that can be used immediately or stored for later use and, further, can optionally be delivered to a location remote from the object. For ease of description, hereinafter reference will be made to a vehicle as the moving object. However, it should be understood that the present invention is not so limited.

Energy recovery system 10 includes a magnetic field generator 12, a conductor 14, such as a bundle of electrically conductive wires, that forms a closed loop circuit, and an energy storage device 16, such as a battery or a capacitor, which stores the energy generated by the current flowing through the circuit. Magnetic field generator 12 may comprise a permanent magnet or an electromagnet and is mounted to vehicle V, such as a car, an SUV, a truck, a bus, a train, or the like. For example, magnetic field generator 12 may comprise a permanent magnet commercially fabricated from such materials as sintered and bonded Neodymium iron boron, or samarium cobalt, or alnico, or ceramics. The dimensions of the magnet depends on the vehicle size and the ultimate magnetic field strength desired at the conductor surface. One example is a permanent magnet of sintered and bonded Neodymium alloy that is 5.75 inches in width and a square cross sectional dimension of 1.93 inches by 1.93 inches. This permanent magnet example can deliver a field strength of approximately 2300 Gauss at a distance of one inch from its 5.75 inch surface facing the conductor. Higher magnetic strength permanent magnets can be designed but this field strength can generate approximately 10 amps of current at 120 volts A.C. in some alternating conductor circuit designs at vehicle speeds around 25 miles per hour.

Conductor 14 is located in the path of the vehicle so that when magnetic field generator 12 passes by conductor 14, current flow is induced in the conductor, which is transmitted to energy storage device 16 for storage and later use, as will be more fully described below. As mentioned above, conductor circuits can be designed with a variety of objectives with respect to current and voltage generation. But basically they are either alternating or direct current circuits. The final conductor design will depend on the specific voltage and current desired and the method of storage and use of the generated electricity. For example, when hydrogen generation is desired then the desired conductor design should be direct current whereas for direct lighting an alternating current conductor circuit might be considered.

As generally noted above, magnetic field generator 12 is mounted to the vehicle so that when the vehicle is traveling and travels across or by conductor 14, magnetic field generator 12 will induce current flow in conductor 14. According to Faraday's Law of Induction, when a magnet or conductor moves relative to the other, for example when a conductor is moved across a magnetic field, a current is caused to circulate in the conductor. Furthermore, when the magnetic force increases or decreases, it produces electricity; the faster it increases or decreases, the more electricity it produces. In other words, the voltage induced in a conductor is proportional to the rate of change of the magnetic flux. In addition, based Faraday's laws and Maxwell's equations, the faster the magnetic field is changing, the larger the voltage that will be induced. Therefore, the faster the vehicle moves past conductor 14, the greater the current flow and, hence, the greater amount of energy stored in storage device 16.

As is known from Lenz' law, when a current flow is induced in conductor 14 it creates a magnetic field in conductor 14, which opposes the change in the external magnetic field, produced by magnetic field generator 12. As a result, the forward motion of the vehicle will be slowed; though the degree to which the forward motion will be slowed will vary depending on the magnitude of the respective fields. In keeping with the goal to recover energy, therefore, conductor 14 is preferably located along the path of vehicle where the vehicle is the most inefficient (i.e. where the vehicle wastes energy) and also where the vehicle has the greatest speed. For example, conductor 14 may be located at a decline, such as on the downhill side of a hill or of a mountain or the like, where the vehicle's speed will increase under the force of gravity over the engine induced speed. On a decline where the speed of the vehicle has increased due to the force of gravity, drivers will often apply their brakes to slow the vehicle to maintain their speed within the speed limit. Ordinarily, the vehicle's engine will run continuously, thus wasting energy, which energy in the present system is recovered. Provided that the reduction in the speed of the vehicle due to the interaction between the two magnetic fields does not exceed the corresponding increase in speed due to gravity, the recovery of energy from the vehicle does not increase the energy consumed by the vehicle. Hence, energy that would otherwise be wasted is recovered from the vehicle. Though it should be understood that the conductor may be positioned at other locations along the path of the vehicle, including locations where the vehicles must begin braking or begin slowing down.

As noted above, conductor 14 preferably comprises a bundle of electrically conductive wires, which are placed in the path (or adjacent the path) of the vehicle. Preferably, the wires are extended across the path, for example across the roadway generally orthogonal to the direction of travel of the vehicle, so that the vehicle passes over the bundle of wires. More preferably, the wires may be incorporated below the road surface of the roadway. For example, the wires may be recessed or embedded in the roadway surface and, further, optionally encapsulated in a body that is recessed or embedded in the roadway. For example, the material forming the body for encapsulating the wires is preferably a non-conductive and/or non-magnetic material, such plastic or rubber or the like, to insulate the wires and to protect the wires from the elements, and road debris.

Referring again to FIG. 1, energy storage device 16 is coupled to a control system 18, which monitors and/or detects when energy storage device 16 has reached or exceeded a threshold level of stored energy. Preferably, control system 18 is configured to transfer energy from storage energy device 16 when the energy level in storage device 16 has reached the threshold level and, further, to transfer the energy to a transmission system or an energy conversion system or the like, where the transferred energy can be used as a supply of energy or to generate resources for some purpose other than driving the vehicle.

For example, control system 18 may transfer the energy to an energy conversion system 20 to transform the energy into another resource, such as a supply of oxygen, hydrogen, or other consumable products. Furthermore, one or more of these products may in turn be used to generate more energy as noted below. In the illustrated embodiment energy conversion system 20 includes an electrolysis system 22 that uses the transferred energy to convert, for example, water into oxygen and hydrogen, which oxygen may be forwarded on to laboratories or hospitals or the like. As noted above, the hydrogen may be used for energy generation. Hydrogen may be used as fuel and an energy supply, including to power vehicles, run turbines or fuel cells, which produce electricity, and to generate heat and electricity for buildings. In the illustrated embodiment, the hydrogen is used to run hydrogen fuel cells 23, which convert hydrogen and oxygen into electricity and can be used to power other vehicles or to provide electricity and heat to buildings. Hence, the current flow in conductor 12 may be used to generate energy and/or to produce products.

As noted above, magnetic field generator 12 may comprise a permanent magnet or an electromagnet. When employing an electromagnet, the magnetic field may be selectively actuated. For example, the vehicle may include a control for actuating the electromagnet. Further, energy recovery system 10 may include a sensor 24 that generates a signal to the vehicle control when the sensor detects that the vehicle is in proximity to conductor 14 so trigger the control to actuate the electromagnet. Sensor 24 may be mounted to the vehicle or may be mounted at or near the conductor.

Referring to FIG. 2, the numeral 30 generally designates a vehicle. Although vehicle 30 is illustrated as an automobile, it should be understood that the term vehicle as used herein is used in its broadest sense to cover any means to carry or transport an object and includes trains, buses, trucks, or the like. As noted above, the faster the speed of the magnetic field generator 12, the greater the rate of energy generation. In the illustrated embodiment, magnetic field generator 12 is mounted to a wheel device 32 of vehicle 30. Alternately, the magnetic field generator 12 may be mounted to a flywheel or the like, for example, that is driven by the vehicle engine.

In preferred form, the negative (N) poles of the magnetic field generator 12 are facing outwardly from the center of the wheel device, so that the poles would be traveling at a higher speed than if mounted at a fixed location on the vehicle. Thus, when the vehicle drives over or adjacent the conductor (14), the rate of rotation of the magnetic field generator 12 would significantly increase the rate of electricity generation per pass over or adjacent the conductor. This same increased energy generation can be used with the magnetic field generator being mounted to a train wheel device.

Furthermore, the rotating magnetic field generator 12 may also comprise a cylindrical structure formed from a plurality of permanent magnets, with one pole oriented towards the perimeter of the cylindrical-shaped member and the other pole being oriented towards the center of the cylindrical-shaped member. This will ensure conservation of Lens' law for induced current directionality within the conductor.

In addition, multiple magnetic field generators may be used in any of the aforementioned applications to thereby further enhance the energy recovery. For example, when this system is employed on a train, each train car could include one or more magnetic field generators so that as each car passes the conductor or conductors, which are preferably located near the track, energy can be generated from each magnetic field generator. While several forms of the invention have been shown and described, other forms will now be apparent to those skilled in the art. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

1. An energy recovery system comprising:
a device producing a magnetic field, said device adapted for mounting to a vehicle; and
a stationary conductor adapted for placing in or adjacent the path of the vehicle wherein said magnetic field induces current to flow through said conductor when the vehicle moves past the conductor.

2. The energy recovery system according to claim 1, wherein said device comprises a permanent magnet.

3. The energy recovery system according to claim 1, wherein said device comprises an electromagnet.

4. The energy recovery system according to claim 3, further comprising a vehicle, said vehicle including a control for actuating said electromagnet.

5. The energy recovery system according to claim 4, further comprising a sensor, said sensor sensing when said vehicle is in proximity to said stationary conductor and generating an actuating signal to said control for actuating said electromagnet.

6. The energy recovery system according to claim 1, further comprising a vehicle, said vehicle including said device.

7. The energy recovery system according to claim 6, wherein said vehicle comprises an automobile.

8. The energy recovery system according to claim 1, wherein said conductor is coupled to an energy storage device.

9. The energy recovery system according to claim 8, wherein said energy storage device comprises a battery.

10. The energy recovery system claim 1, wherein said conductor is coupled to an energy conversion system.

11. The energy recovery system claim 10, wherein said energy conversion system includes at least one hydrogen fuel cell.

12. The energy recovery system claim 11, wherein said energy conversion system includes an electrolysis system for generating at least hydrogen for said hydrogen fuel cell.

13. An energy recovery system comprising:
a vehicle;
a device producing a magnetic field, said device mounted to said vehicle; and
a circuit, said circuit including a stationary conductor adapted for placing in the path of said vehicle when the vehicle is moving wherein said magnetic field induces current to flow through said circuit when said vehicle passes by said conductor.

14. The energy recovery system according to claim 13, wherein said conductor comprises a bundle of wiring.

15. The energy recovery system according to claim 14, wherein said bundle of wiring is adapted for being mounted in a road surface.

16. The energy recovery system according to claim 15, wherein said device comprises a permanent magnet.

17. The energy recovery system according to claim 15, wherein said device comprises an electromagnet.

18. The energy recovery system according to claim 17, further comprising a control for selectively actuating said electromagnet when said vehicle is in at least proximity to said conductor.

19. The energy recovery system according to claim 18, further comprising a sensor, said sensor sensing when said vehicle is in proximity to said stationary conductor and generating an actuating signal to said control for actuating said electromagnet.

20. The energy recovery system according to claim 13, wherein said vehicle comprises an automobile.

21. The energy recovery system according to claim 13, wherein said circuit is coupled to an energy storage device.

22. The energy recovery system according to claim 21, wherein said energy storage device is coupled to an energy conversion system.

23. The energy recovery system according to claim 22, wherein said energy storage device is selectively coupled to an energy conversion system.

24. A method of recovering energy comprising:
mounting a magnetic field generating device to a vehicle;
providing a stationary conductor in the path of the vehicle wherein the magnetic field generates current flow in the conductor when the vehicle travels past the conductor; and
coupling the conductor to at least one chosen from an energy storage device, a transmission system, and an energy conversion system.

25. The method of recovering energy according to claim 24, wherein said coupling the conductor comprises coupling the conductor to an energy storage device.

26. The method of recovering energy according to claim 25, further comprising coupling said energy storage device with an energy transmission system.

27. The method of recovering energy according to claim 26, further comprising detecting when said energy storage device has stored energy above a predetermined threshold and transmitting energy from said energy storage device to said energy transmission system when said stored energy exceed said predetermined threshold.

28. The method of recovering energy according to claim 24, further comprising selectively actuating the magnetic field generating device to thereby selectively generate the magnetic field.
